(19) United States
(12) Patent Application Publication
(10) Pub. No.: US 2002/0178004 A1
(43) Pub. Date: Nov. 28, 2002

(54) Method and apparatus for voice recognition

(76) Inventors: Chienchung Chang, Rancho Santa Fe., CA (US); Narendranath Malayath, San Diego, CA (US)

Correspondence Address: Sarah Kirkpatrick, Manager, Intellectual Property Administration, QUALCOMM Incorporated, 5775 Morehouse Drive, San Diego, CA, 92121-1714, US

(21) Appl. No.: 09/864,059

(22) Filed: May 23, 2001

(51) Int. Cl. G10L 17/00

(52) U.S. Cl. 704/246

(57) ABSTRACT

A voice recognition system applies user inputs to adapt speaker-dependent voice recognition templates using implicit user confirmation during a transaction. In one embodiment, the user confirms the vocabulary word to complete at transaction, such as entry of a password, and in response a template database is updated. User utterances are used to generate test templates that are compared to the template database. Scores are generated for each test template and a winner selected. The template database includes one set of speaker independent templates and two sets of speaker dependent templates.

### BACKGROUND

1. Field

The present invention relates to speech signal processing. More particularly, the present invention relates to a novel method and apparatus for voice recognition using confirmation information provided by the speaker.

2. Background

The increasing demand for Internet accessibility creates a need for wireless communication devices capable of Internet access, thus allowing users access to a variety of information. Such devices effectively provide a wireless desktop wherever wireless communications are possible. As users have access to a variety of information services, including email, stock quotes, weather updates, travel advisories, and company news, it is no longer acceptable for a mobile worker be out of contact while traveling. A wealth of information and services are available through wireless devices, including information for personal consumption such as movie schedules, local news, sports scores, etc.

As many wireless devices, such as cellular telephones, have some form of speech processing capability, there is a desire to implement voice control and avoid keystrokes when possible. Typical Voice Recognition, VR, systems are designed to have the best performance over a broad number of users, but are not optimized to any single user. For some users, such as users having a strong foreign accent, the performance of a VR system can be so poor that they cannot effectively use VR services at all. There is a need therefore for a method of providing voice recognition optimized for a given user.

### SUMMARY

The methods and apparatus disclosed herein are directed to a novel and improved VR system. In one aspect, a voice recognition system includes a speech processor operative to receive an analog speech signal and generate a digital signal, a database operative to store voice recognition templates, and a memory storage unit coupled to the speech processor and the database, the memory storage unit operative to store the digital signal, the memory storage unit operative to update the voice recognition templates based on the digital signal and an implicit user confirmation.

In another aspect, a method for voice recognition in a wireless communication device, the device having a voice recognition template database, the device adapted to receive speech inputs from a user, includes calculating a test template based on a test utterance, matching the test template to a voice recognition template in the database, the voice recognition template having an associated vocabulary word, providing the vocabulary word as feedback, receiving an implicit user confirmation from a user, and updating the database in response to the implicit user confirmation.

In still another aspect, a wireless apparatus includes a speech processor operative to receive an analog speech signal and generate a digital signal, a database operative to store voice recognition templates, and a memory storage unit coupled to the speech processor and the database, the memory storage unit operative to store the digital signal, the memory storage unit operative to update the voice recognition templates based on the digital signal and an implicit user confirmation. Additionally, the apparatus includes a template matching unit coupled to the speech processor, the database, and the template matching unit, operative to compare the digital signals to the voice recognition templates and generating scores, and a selector coupled to the template matching unit and the database, the selector operative to select among the scores.

The word “exemplary” is used herein to mean “serving as an example, instance, or illustration.” Any embodiment described as an “exemplary embodiment” is not necessarily to be construed as being preferred or advantageous over another embodiment.

### BRIEF DESCRIPTION OF THE DRAWINGS

The features, objects, and advantages of the presently disclosed method and apparatus will become more apparent from the detailed description set forth below when taken in conjunction with the drawings in which like reference characters identify correspondingly throughout and wherein:

FIG. 1 is a wireless communication device;

FIG. 2 is a portion of a VR system;

FIG. 3 is an example of a speech signal;

FIGS. 4-5 are a VR system;

FIG. 6 is a speech processor;

FIG. 7 is a flowchart illustrating a method for performing voice recognition using user confirmation; and

FIG. 8 is a portion of a VR system implementing an HMM algorithm.

### DETAILED DESCRIPTION

Command and control applications for wireless devices applied to speech recognition allow a user to speak a command to effect a corresponding action. As the device correctly recognizes the voice command, the action is initiated. One type of command and control application is a voice repertory dialer that allows a caller to place a call by speaking the corresponding name stored in a repertory. The result is “hands-free” calling, thus avoiding the need to dial the digit codes associated with the repertory name or manually scroll through the repertory to select the target call recipient. Command and control applications are particularly applicable in the wireless environment.

A command and control type speech recognition system typically incorporates a speaker-trained set of vocabulary patterns corresponding to repertory names, a speaker-independent set of vocabulary patterns corresponding to digits, and a set of command words for controlling normal telephone functions. While such systems are intended to be speaker-independent, some users, particularly those with strong accents, have poor results using these devices. It is desirable to speaker-train the vocabulary patterns corresponding to digits and the command words to enhance the performance of the system per individual user.

Systems that employ techniques to recover a linguistic message from an acoustic speech signal are called voice recognition, VR, systems. Voice recognition represents one of the most important techniques to endow a machine with simulated intelligence to recognize user voiced commands and to facilitate human interface with the machine. A basic VR system consists of an acoustic feature extraction (AFE) unit and a pattern matching engine. The AFE unit converts a series of digital voice samples into a set of measurement values (for example, extracted frequency components) called an acoustic feature vector. The pattern matching engine matches a series of acoustic feature vectors with the templates contained in a VR acoustic model. VR pattern matching engines generally employ either Dynamic Time Warping (DTW) or Hidden Markov Model (HMM) techniques. Both DTW and HMM are well known in the art, and are described in detail in Rabiner, L. R. and Juang, B. H., FUNDAMENTALS OF SPEECH RECOGNITION, Prentice Hall, 1993. When a series of patterns are recognized from the template, the series is analyzed to yield a desired format of output, such as an identified sequence of linguistic words corresponding to the input utterances.

As noted above, the acoustic model is generally either a HMM model or a DTW model. A DTW acoustic model may be thought of as a database of templates associated with each of the words that need to be recognized. In general DTW templates consist of a sequence of feature vectors (or modified feature vectors) which are averaged over many examples of the associated speech sound. In general an HMM templates stores a sequence of mean vectors, variance vectors and a set of transition probabilities. These parameters are used to describe the statistics of a speech unit and are estimated from many examples of the speech unit. These templates correspond to short speech segments such as phonemes, tri-phones or words.

“Training” refers to the process of collecting speech samples of a particular speech segment or syllable from one or more speakers in order to generate templates in the acoustic model. Each template in the acoustic model is associated with a particular word or speech segment called an utterance class. There may be multiple templates in the acoustic model associated with the same utterance class. “Testing” refers to the procedure for matching the templates in the acoustic model to the sequence of feature vectors extracted from the input utterance. The performance of a given system depends largely upon the degree of match between the input speech of the end-user and the contents of the database, and hence on the match between the reference templates created through training and the speech samples used for VR testing.

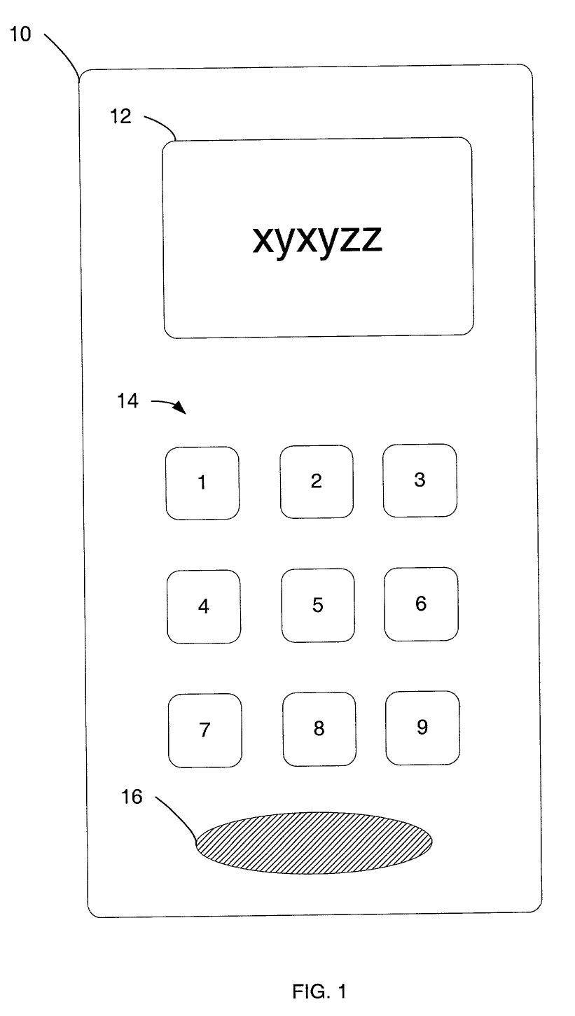

In one embodiment illustrated in FIG. 1, a wireless device 10 includes a display 12 and a keypad 14. The wireless device 10 includes a microphone 16 to receive voice signals from a user. The voice signals are converted into electrical signals in microphone 16 and are then converted into digital speech samples in an analog-to-digital converter, A/D. The digital sample stream is then filtered using a pre-emphasis filter, for example a finite impulse response, FIR, filter that attenuates low-frequency signal components.

The filtered samples are then converted from digital voice samples into the frequency domain to extract acoustic feature vectors. One process performs a Fourier Transform on a segment of consecutive digital samples to generate a vector of signal strengths corresponding to different frequency bins. In an exemplary embodiment, the frequency bins have varying bandwidths in accordance with a scale referred to as a bark scale. A bark scale is a nonlinear scale of frequency bins corresponding to the first 24 critical bands of hearing. The bin center frequencies are only 100 Hz apart at the low end of the scale (50 Hz, 150 Hz, 250 Hz, . . . ) but get progressively further apart at the upper end (4000 Hz, 4800 Hz, 5800 Hz, 7000 Hz, 8500 Hz, . . . ). Thus, the bandwidth of each frequency bin bears a relation to the center frequency of the bin, such that higher-frequency bins have wider frequency bands than lower-frequency bins. The allocation of bandwidths reflects the fact that humans resolve signals at low frequencies better than those at high frequencies—that is, the bandwidths are lower at the low-frequency end of the scale and higher at the high-frequency end. The bark scale is described in Rabiner, L. R. and Juang, B. H., Fundamentals of Speech Recognition, Prentice Hall, 1993, pp. 77-79, hereby expressly incorporated by reference. The bark scale is well known in the relevant art.

In an exemplary embodiment, each acoustic feature vector is extracted from a series of speech samples collected over a fixed time interval. In an exemplary embodiment, these time intervals overlap. For example, acoustic features may be obtained from 20-millisecond intervals of speech data beginning every ten milliseconds, such that each two consecutive intervals share a 10-millisecond segment. One skilled in the art would recognize that the time intervals might instead be non-overlapping or have non-fixed duration without departing from the scope of the embodiments described herein.

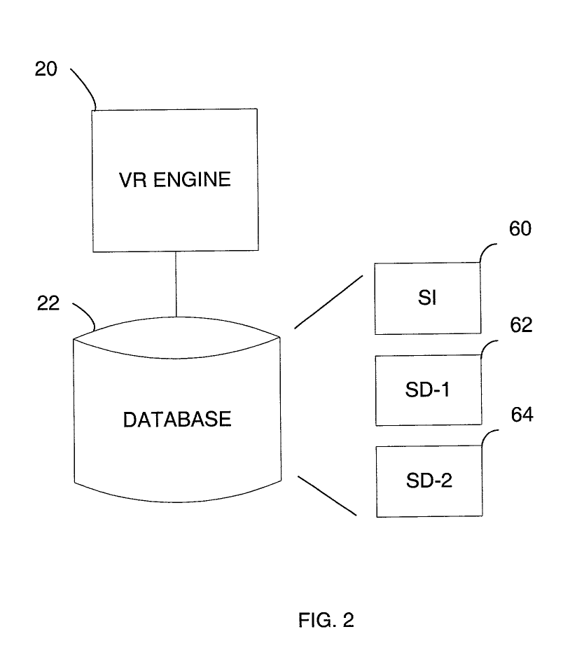

A large number of utterances are analyzed by a VR engine 20 illustrated in FIG. 2 storing a set of VR templates. The VR templates contained in database 22 are initially Speaker-independent (SI) templates. The SI templates are trained using the speech data from a range of speakers. The VR engine 20 develops a set of Speaker-Dependent (SD) templates adapting the templates to the individual user. As illustrated the templates include one set of SI templates labeled SI 60, and two sets of SD templates labeled SD-1 62, and SD-2 64. Each set of templates contains the same number of entries. In conventional VR systems, SD templates are generated through supervised training, wherein a user will provide multiple utterances of a same phrase, character, letter or phoneme to the VR engine. The multiple utterances are recorded and acoustic features extracted. The SD templates are then trained using these features.

In the exemplary embodiment, training is enhanced with user confirmation, wherein the user speaks an alphanumeric entry to the microphone 16. The VR engine 20 associates the entry with a template in the database 22. The entry from the database 22 is then displayed on display 12. The user is then prompted for a confirmation. If the displayed entry is correct, the user confirms the entry and the VR engine develops a new template based on the user's spoken entry. If the displayed entry is not correct, the user indicates that the display is incorrect. The user may then repeat the entry or retry. The VR engine stores each of these utterances in memory, iteratively adapting to the user's speech. In one embodiment, after each utterance, the user uses the keypad to provide the spoken entry. In this way, the VR engine 20 is provided with a pair of the user's spoken entry and the confirmed alphanumeric entry.

The training is performed while the user is performing transactions, such as entering identification, password information, or any other alphanumeric entries used to conduct transactions via an electronic device. In each of these transactions, and a variety of other type transactions, the user enters information that is displayed or otherwise provided as feedback to the user. If the information is correct, the user completes the current step in the transaction, such as enabling a command to send information. This may involve hitting a send key or a predetermined key on an electronic device, such as a “#” key or an enter key. In an alternate embodiment, the user may confirm a transaction by a voice command or response, such as speaking the word “yes.” The training uses these transaction confirmations, herein referred to as “user transaction confirmations,” to train the VR templates. Note that the user may not be aware of the reuse of this information to train the templates, in contrast to a system wherein the user is specifically asked to confirm an input during a training mode. In this way, the user transaction confirmation is an implicit confirmation.

The input to microphone 16 is a user's utterance of an alphanumeric entry, such as an identification number, login, account number, personal identification number, or a password. The utterance may be a single alphanumeric entry or a combinational multi-digit entry. The entry may also be a command, such as backward or forward, or any other command used in an Internet type communication.

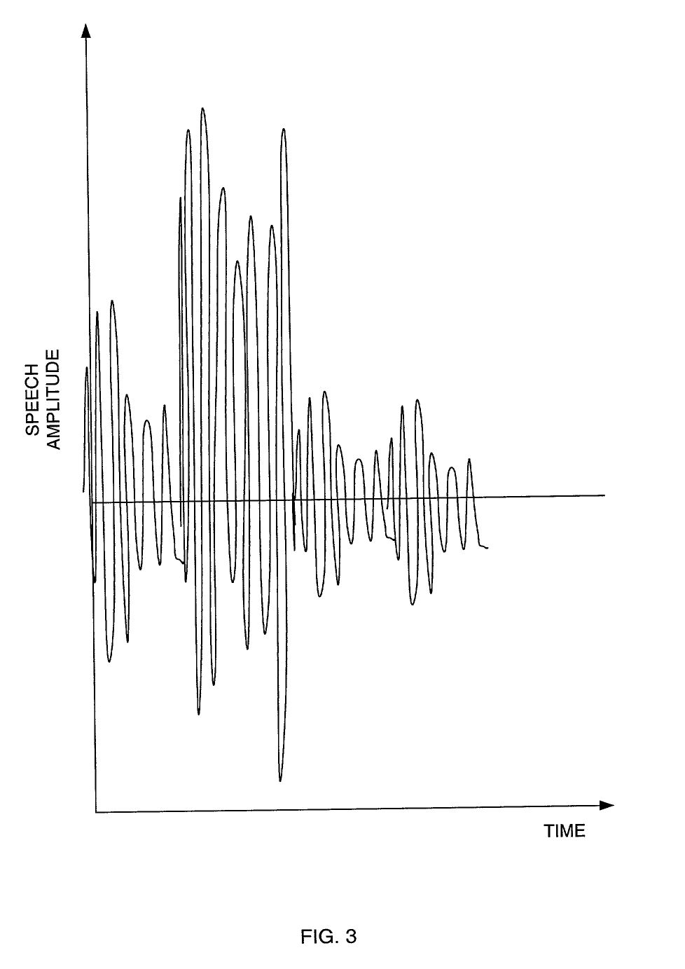

As discussed hereinabove, the VR database stores templates of acoustical features and/or patterns that identify phrases, phenomes, and/or alpha-numeric values. Statistical models are used to develop the VR templates based on the characteristics of speech. A sample of an uttered entry is illustrated in FIG. 3. The amplitude of the speech signal is plotted as a function of time. As illustrated, the variations in amplitude with respect to time identify the individual user's specific speech pattern. A mapping to the uttered value results in a SD template.

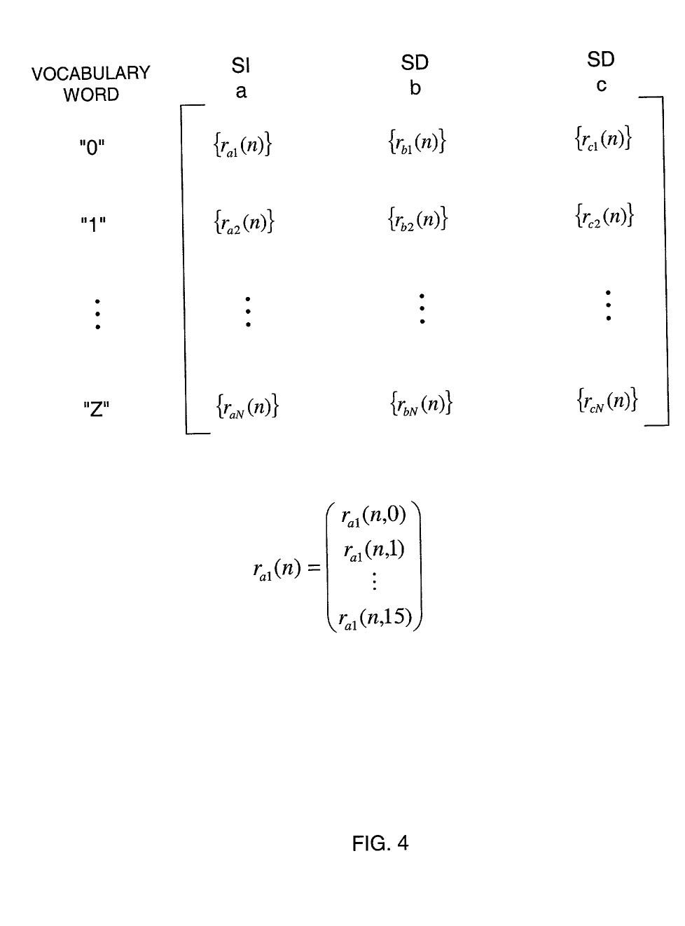

A set of templates according to one embodiment is illustrated in FIG. 4. Each row corresponds to an entry, referred to as a vocabulary word, such as “0”, “1”, or “A”, “Z”, etc. The total number of vocabulary words in an active vocabulary word set is identified as N, wherein in the exemplary embodiment, the total number of vocabulary words includes ten numeric digits and 26 alphabetic letters. Each vocabulary word is associated with one SI template and two SD templates. Each template is a 1×n matrix of vectors, wherein n is the number of features included in a template. In the exemplary embodiment, n=20.

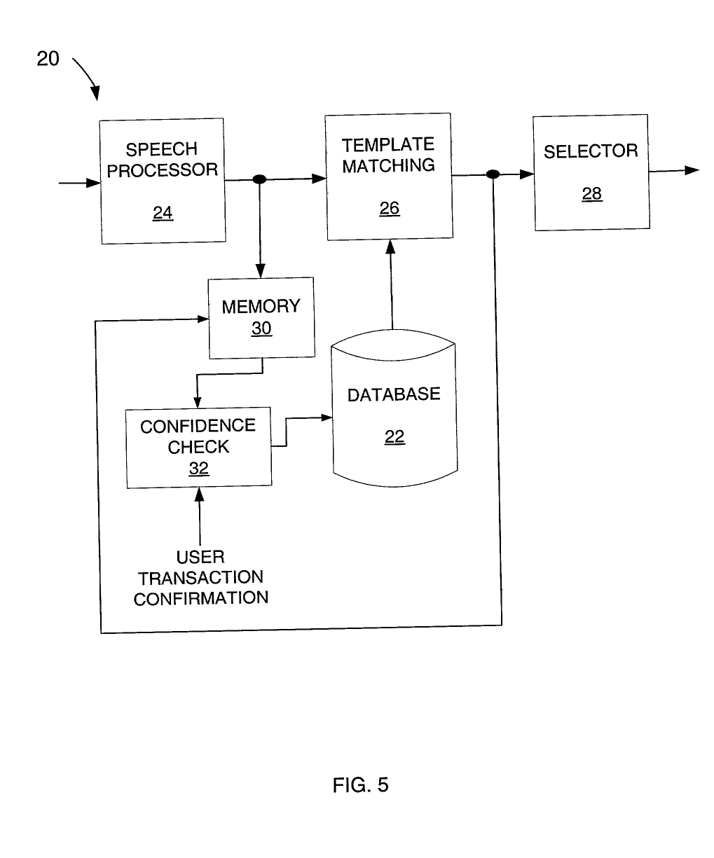

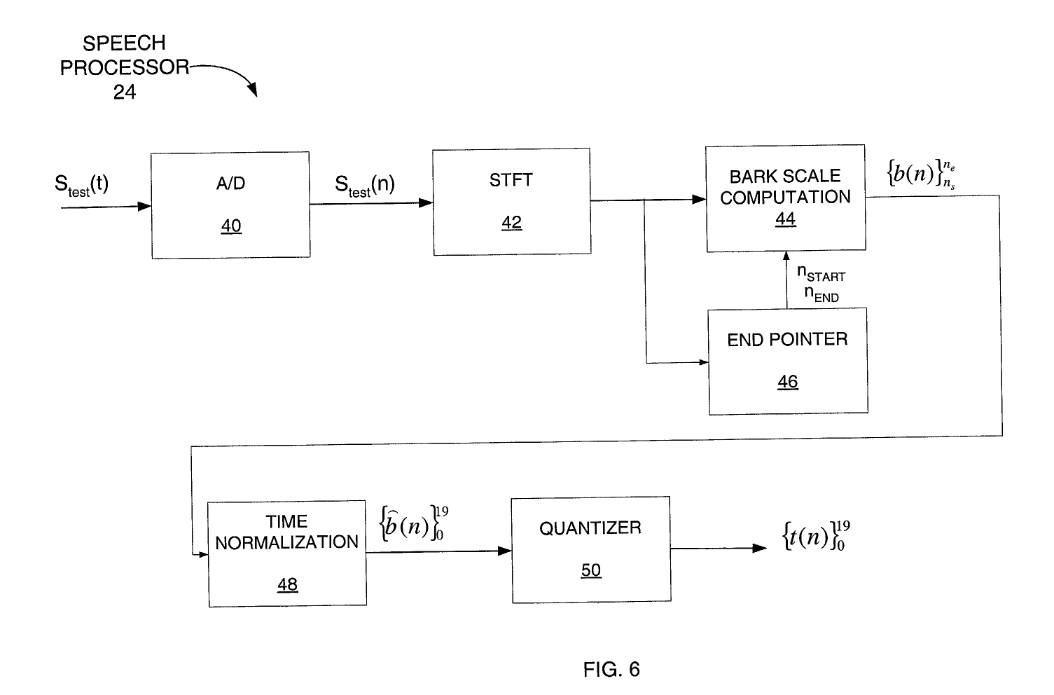

FIG. 5 illustrates VR engine 20 and database 22 according to an exemplary embodiment. The utterance is received via a microphone (not shown), such as microphone 16 of FIG. 1, at the speech processor 24. The speech processor 24 is further detailed in FIG. 6, discussed hereinbelow. The input to the speech processor 24 is identified as Sₜₑₛₜ(t). The speech processor converts the analog signal to a digital signal and applies a Fourier Transform to the digital signal. A Bark scale is applied, and the result normalized to a predetermined number of time frames. The result is then quantized to form an output {t(n)ₙ₌₀^{T}}, wherein T is the total number of time frames. The output of speech processor 24 is provided to template matching unit 26 and memory 30, which are each coupled to speech processor 24.

Template matching unit 26 is coupled to database 22 and accesses templates stored therein. Template matching unit 26 compares the output of the speech processor 24 to each template in database 22 and generates a score for each comparison. Template matching unit 26 is also coupled to selector 28, wherein the selector 28 determines a winner among the scores generated by template matching unit 26. The winner has a score reflecting the closest match of input utterance to a template. Note that each template within database 22 is associated with a vocabulary word. The vocabulary word associated with the winner selected by selector 28 is displayed on a display, such as display 12 of FIG. 1. The user then provides a confirmation that the displayed vocabulary word matches the utterance or indicates a failed attempt. The confidence check unit 32 receives the information from the user.

Memory 30 is coupled to template matching unit 26 via confidence check unit 32. The templates and associated scores generated by template matching unit 26 are stored in memory 30, wherein upon control from the confidence check unit 32 the winner template(s) is stored in database 22, replacing an existing or older template.

FIG. 6 details one embodiment of a speech processor 24 for generating t(n) consistent with a DTW method as described hereinabove. An A/D converter 40 converts the analog test utterance Sₜₑₛₜ(t) to a digital version. The resultant digital signal Sₜₑₛₜ(n) is provided to a Short-Time Fourier Transform, STFT, unit 42 at 8000 samples per second, i.e., 8 kHz. The STFT is a modified version of a Fourier Transform, FT, that handles signals, such as speech signals, wherein the amplitude of the harmonic signal fluctuates with time. The STFT is used to window a signal into a sequence of snapshots, each sufficiently small that the waveform snapshot approximates a stationary waveform. The STFT is computed by taking the Fourier transform of a sequence of short segments of data. The STFT unit 42 converts the signal to the frequency domain. Alternate embodiments may implement other frequency conversion methods. In the present embodiment, the STFT unit 42 is based on a 256 point Fast Fourier Transform, FFT, and generates 20 ms frames at a rate of 100 frames per second.

The output of the STFT unit 42 is provided to bark scale computation unit 44 and an end pointer 46. The end pointer provides a starting point, n_{START}, and an ending point, N_{END}, for the bark scale computation unit 44 identifying each frame. For each frame the bark scale computation unit 44 generates a bark scale value, {b(n,k)}, where k is bark-scale filter index (k=1,2, . . . 16) and n is the time frame index (n=0,1 . . . t). The output of the bark scale computation unit 44 is provided to time normalization unit 48 which condenses the t frame bark scale values {b(n,k)} to 20 frame values { [symbol] (n,k)}, where n ranges from 0 to 19 and k ranges from 1 to 16. The output of the time normalization unit 48 is provided to a quantizer 50. The quantizer 50 receives the values { [symbol] (n,k)} and performs a 16:2 bit quantization thereto. The resulting output is { [symbol] (n,k)} or {t (n)} for n=0,19. Alternate embodiments may employ alternate methods of processing the received speech signal.

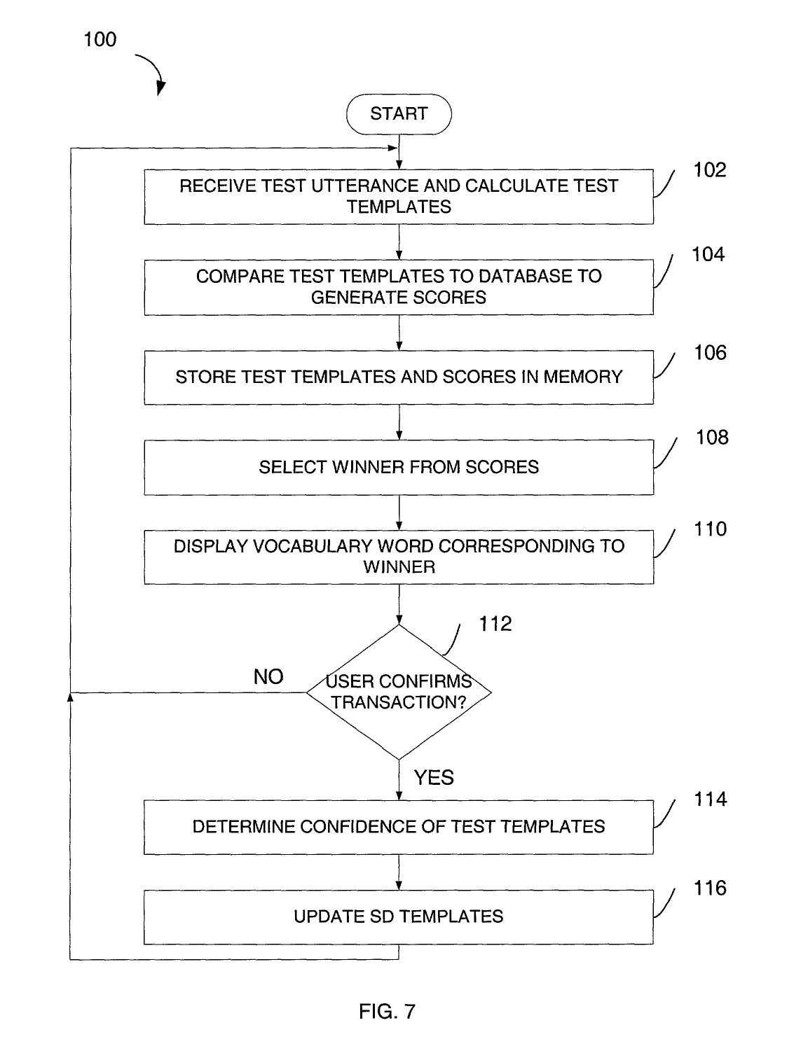

A method 100 of processing SD templates is illustrated in FIG. 7. The process begins at step 102 where a test utterance is received from a user. From the test utterance the VR engine generates test templates (as described in FIG. 6). The test templates compared to the templates in the database at step 104. A score is generated for each comparison. Each score reflects the closeness of the test template to a template in the database. Any of a variety of methods may be used to determine the score. One example is Euclidian distance based dynamic time warping, which is well known in the art. The test templates and the associated scores are temporarily stored in memory at step 106. A winner is selected from the generated scores at step 108. The winner is determined based on the score indicating the most likely match. The winner is a template that identifies a vocabulary word. The corresponding vocabulary word is then displayed for the user to review at step 110. In one embodiment the display is an alphanumeric type display, such as display 12 of FIG. 1. In an alternate embodiment, the vocabulary word corresponding to the winner may be output as a digitally generated audio signal from a speaker located on the wireless device. In still another embodiment, the vocabulary word is displayed on a display screen and is provided as an audio output from a speaker.

The user then is prompted to confirm the vocabulary word at decision diamond 112. If the VR engine selected the correct vocabulary word, the user will confirm the match and processing continues to step 114. If the vocabulary word is not correct, the user indicates a failure and processing returns to step 102 to retry with another test utterance. In one embodiment, the user is prompted for confirmation of each vocabulary word within a string. In an alternate embodiment, the user is prompted at completion of an entire string, wherein a string may be a user identification number, password, etc.

When the user confirms the vocabulary word, the VR engine performs a confidence check to verify the accuracy of the match. The process compares the confidence level of the test template to that of any existing SD templates at step 114. When the test template has a higher confidence level than an existing SD template for that vocabulary word, the test template is stored in the database at step 116, wherein the SD templates are updated. Note that the comparison may involve multiple test templates, each associated with one vocabulary word in a string.

According to one embodiment, when the process 100 of FIG. 6 is initiated when there is no match between a received voice command and any of the templates stored in the database. In this case, the display will prompt the user to provide a test utterance, and may indicate the device is in a training mode.

The wireless device may store template information, including but not limited to templates, scores, and/or training sequences. This information may be statistically processed to determine optimize system recognition of a particular user. A central controller or a base station may periodically query the wireless device for this information. The wireless device may then provide a portion or all of the information to the controller. Such information may be processed to optimize performance for a geographical area, such as a country or a province, to allow the system to better recognize a particular accent or dialect.

In one embodiment, the user enters the alphanumeric information in a different language. During training, the user confirmation process allows the user to enter the utterance and press the associated keypad entry. In this way, the VR system allows native speech for command and control.

For application to user identification type information, the set of vocabulary words may be expanded to include, for example, a set of Chinese characters. Thus a user desiring to enter a Chinese character or string as an identifier may apply the voice command and control process. In one embodiment, the device is capable of displaying one or several sets of language characters.

The process 100 detailed in FIG. 6 as implemented in the VR engine 20 of FIG. 5 stores the output of speech processor 24 t(n) temporarily in memory 30, awaiting a confirmation by the user. The value t(n) stored in the memory 30 is also provided to template matching unit 26 for comparison with templates in the database 22, score assignment, and selection of a winner as described hereinabove. Each template t(n) is compared to each of the templates stored in the database. For example, considering the database 22 illustrated in FIG. 2, having three sets: SI, SD-1, SD-2, and N vocabulary words, the template matching unit 26 will generate 3×N scores for t(n). The scores are provided to the selector 28, which determines the closest match.

Upon confirmation by the user, the stored t(n) is provided to confidence check unit 32 for comparison with existing SD entries. If the confidence level of t(n) is greater than the confidence level of an existing entry, the existing entry is replaced with t(n), else, the t(n) stored in memory may be ignored. Alternate embodiments may store t(n) on each confirmation by the user.

Allowing the user to confirm the accuracy of the voice recognition decisions during a training mode enhances the VR capabilities of a wireless device. VR templates are adapted to achieve implicit speaker adaptation, ISA, by incorporating user confirmation information. In this way, a device is adapted to allow VR entry of user identification information, password, etc., specific to a user. For example, after a user enters his ‘User Name’ and ‘Password’ ISA is achieved upon confirmation by pressing an OK key. Speaker trained templates are then used to enhance performance of the alpha-numeric engine each time the user logs on, i.e., enters this information. The training is performed during normal operation of the device, and allows the user enhanced VR operation.

In one embodiment, the VR engine is phonetic allowing both dynamic and static vocabulary words, wherein the dynamic vocabulary size may be determined by the application, such as web browsing. The advantages to the wireless user include hands-free and eyes-free operation, efficient Internet access, streamlined navigation, and generally user-friendly operation.

In one embodiment, the VR SD templates and training are used to implement security features on the wireless device. For example, the wireless device may store the SD templates or a function thereof as identification. In one embodiment, the device is programmed to disallow other speakers to use the device.

In an alternate embodiment, the speech processing, such as performed by speech processor 24 of FIG. 5, is consistent with an HMM method, as described hereinabove.

HMMs model words (or sub-word units like phonemes or triphones) as a sequence of states. Each state contains parameters, e.g., means and variances, that describe the probability distribution of predetermined acoustic features. In a speaker independent system, these parameters are trained using speech data collected from a large number of speakers. Methods for training the HMM models are will known in the art, wherein one method of training is referred to as the Baum-Welch algorithm. According to this algorithm, during testing, a sequence of feature vectors, X, are extracted from the utterance. The probability that this sequence is generated by all the contesting HMM models is computed using a standard algorithm, such as Viterbi type decoding. The utterance is recognized as the word (or sequence of words), which gives the highest probability.

As the HMM models are trained using the speech of many speakers and hence can work well over a large population of speakers. The performance could vary drastically over speakers depending on how well the speaker is represented by the population of speakers used to train the acoustic models. For example, a non-native speaker or a speaker with a peculiar accent can result in a significant degradation of performance.

Adaptation is an effective method to alleviate degradations in recognition performance caused by the mismatch between the voice characteristics of the end user and the once captured by the speaker-independent HMM. Adaptation modifies the model parameters during testing to closely match with the test speaker. If the sequence X is the set of feature vectors used while testing and M is the set of model parameters then, M can be modified to match with the statistical characteristics of X. Such a modification of HMM parameters can be done using various techniques like Maximum Likelihood Linear Regression, MLLR, or Maximum A Posteriori, MAP, adaptation. These techniques are well known in the art and the details can be found in C. J. Leggetter, P. C. Woodland: “Maximum Likelihood linear regression for speaker adaptation of continuous density hidden Markov models”, Computer, Speech and Language, vol. 9, pp. 171-185, 1995, and Chin-Hui Lee et. al.:” A study on speaker adaptation of the parameters of continuous density hidden Markov models”, IEEE transactions on signal processing”, vo.39, pp. 806-814.

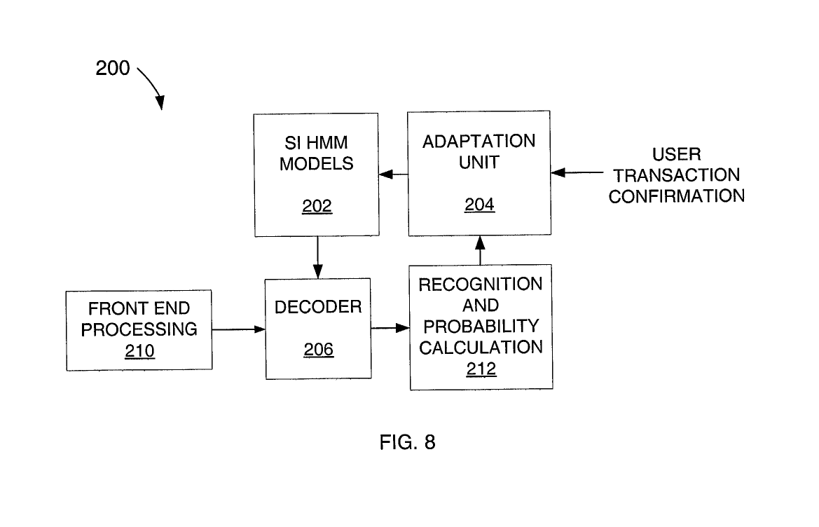

For performing supervised adaptation the label of the utterance is also required. FIG. 8 illustrates a system 200 for implementing the HMM method. The Speaker Independent, SI, HMM models are stored in a database 202. The SI HMM models from database 202 and the results of front end processing unit 210 are provided to decoder 206. The front end processing unit 210 processing received utterances from a user. The decoded information is provided to recognition and probability calculation unit 212. The unit 212 determines a match between the received utterance and stored HMM models. The unit 212 provides the results of these comparisons and calculations to adaptation unit 204. The adaptation unit 204 updates the HMM models based on the results of unit 212 and user transaction confirmation information.

In an alternate embodiment, user transaction confirmation information is applied to recognition of handwriting. The user enters handwriting information into an electronic device, such as a Personal Digital Assistant, PD. The user uses the input handwriting to initiate or transact a transaction. When the user makes a transaction confirmation based on the input handwriting, a test template is generated based on the input handwriting. The electronic device analyzes the handwriting to extract predetermined parameters that form the test template. Analogous to the speech processing embodiment illustrated FIG. 5; a handwriting processor replaces the speech process 24, wherein handwriting templates are generated based on handwriting inputs by the user. These User Dependent, UD, templates are compared to handwriting templates stored in a database analogous to database 22. A user transaction confirmation triggers a confidence check to determine if the test template has a higher confidence level than a UD template stored in the database. The database includes a set of User Independent, UI, templates and at least one UD template. The adaptation process is used to update the UD templates.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A voice recognition system comprising:
a speech processor operative to receive an analog speech signal and generate a digital signal;
a database operative to store voice recognition templates; and
a memory storage unit coupled to the speech processor and the database, the memory storage unit operative to store the digital signal, the memory storage unit operative to update the voice recognition templates based on the digital signal and an implicit user confirmation.

2. The voice recognition system of claim 1 further comprising:
a template matching unit coupled to the speech processor, the memory storage unit, and the database, the template matching unit operative to compare the digital signal to the voice recognition templates in the database.

3. The voice recognition system of claim 2 wherein the template matching unit is operative to generate scores corresponding to each comparison of the digital signal to one of the voice recognition templates.

4. The system of claim 1, wherein the user implicit confirmation is a transaction confirmation.

5. The system of claim 4, wherein the transaction is to enter a user identification.

6. The system of claim 4, further comprising:
means for displaying the vocabulary word.

7. A method for voice recognition in a wireless communication device, the device having a voice recognition template database, the device adapted to receive speech inputs from a user, comprising:
calculating a test template based on a test utterance;
matching the test template to a voice recognition template in the database, the voice recognition template having an associated vocabulary word;
providing the vocabulary word as feedback;
receiving an implicit user confirmation from a user; and
updating the database in response to the implicit user confirmation.

8. A method as in claim 7, wherein the test template includes multiple entries, the method further comprising:
comparing the test template entries to the database; and
generating scores for the test template entries.

9. A method as in claim 8, further comprising:
selecting a sequence of winners based on the scores of the multiple entries.

10. A method as in claim 9, further comprising:
determining a confidence level of each of the multiple entries of the test template.

11. A method as in claim 7, wherein the implicit user confirmation is a transaction confirmation.

12. A method as in claim 11, wherein the transaction is to enter a user identification.

13. A method as in claim 7, wherein providing the vocabulary word further comprises:
displaying the vocabulary word.

14. A wireless apparatus, comprising:
a speech processor operative to receive an analog speech signal and generate a digital signal;
a database operative to store voice recognition templates;
a memory storage unit coupled to the speech processor and the database, the memory storage unit operative to store the digital signal, the memory storage unit operative to update the voice recognition templates based on the digital signal and an implicit user confirmation;
a template matching unit coupled to the speech processor, the database, and the template matching unit, operative to compare the digital signals to the voice recognition templates and generating scores; and
a selector coupled to the template matching unit and the database, the selector operative to select among the scores.

15. An apparatus as in claim 14, wherein the voice recognition templates further comprise:
a plurality of templates associated with a plurality of vocabulary words, each of the plurality of templates representing multiple characteristics of speech.

16. An apparatus as in claim 15, wherein the template matching unit generates test templates from the digital signals.

17. An apparatus as in claim 15, wherein the test templates are specific to a given user, and wherein the test templates are used to update the voice recognition templates.

18. An apparatus as in claim 17, wherein the test templates are used to identify the user.

19. An apparatus as in claim 17, wherein the voice recognition templates comprise:
a first set of speaker independent templates; and
two sets of speaker dependent templates.

20. An apparatus as in claim 17, wherein the template matching unit generates test templates from the digital signals.

21. An apparatus as in claim 14, wherein the template matching unit generates test templates from the digital signals.

22. A handwriting recognition system comprising:
a handwriting processor operative to receive an analog input handwriting signal and generate a digital signal;
a database operative to store handwriting recognition templates; and
a memory storage unit coupled to the handwriting processor and the database, the memory storage unit operative to store the digital signal, the memory storage unit operative to update the handwriting recognition templates based on the digital signal and an implicit user confirmation.
